(19) United States
(12) Patent Application Publication
(10) Pub. No.: US 2007/0239522 A1
(43) Pub. Date: Oct. 11, 2007

(54) User Persona Content Targeting

(75) Inventors: Michael C. Kunz, Seattle, WA (US); Melora Zaner-Godsey, Seattle, WA (US); Martin J. Hall, Seattle, WA (US); Allison O'Mahony, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/278,086

(22) Filed: Mar. 30, 2006

(51) Int. Cl. G06Q 30/00

(52) U.S. Cl. 705/14

(57) ABSTRACT

User persona content targeting is described. In an embodiment, a targeted content system includes a client account that corresponds to a user of computing-based client device(s), and the client account is associated with multiple personas that are each a different on-line representation of the user. A persona system initiates content being targeted to the user via a computing-based client device when the user is represented on-line as a first persona, and then initiates different content being targeted to the user via the computing-based client device when the user is represented on-line as a second persona.

### BACKGROUND

A user has access to a variety of different types of services, both locally and remotely over a network. For example, the user may shop at an ecommerce Web site, write in a “blog” (i.e., Weblog), read and respond to messages in a message board, communicate using instant messages, send and receive email, and so on. In addition, the user may interact with a variety of different groups using each of these services. For example, the user may interact with a variety of social groups via instant messaging, including work colleagues, college and other friends, family members, and the like.

To interact with and utilize the variety of services, a user may be required to have a client account and to log-in to the service by providing sign-in credentials, such as a user name and password. Once the user is logged into traditional systems, however, the user is typically limited to a single representation of the user, such as a user tile, alias, and other profile information. Although the user may interact with a variety of different social groups, such as work colleagues and family members, the user is typically presented to others with the same on-line representation of the user.

Advertisers and others seeking to deliver targeted content to on-line or networked users are also presented with the one on-line representation of the user, and can only direct content and advertising based on the general profile information associated with the user. Generally, the profile of a user is created when the client account for the user is established, and may not reflect or represent many of the interests of the user. As such, advertisements and the other content is more so targeted to the account, rather than to the user based on the various interactions with the different social groups.

### SUMMARY

This summary is provided to introduce simplified concepts of user persona content targeting which is further described below in the Detailed Description. This summary is not intended to identify essential features of the claimed subject matter, nor is it intended for use in determining the scope of the claimed subject matter.

In an embodiment of user persona content targeting, a targeted content system includes a client account that corresponds to a user of computing-based client device(s), and the client account is associated with multiple personas that are each a different on-line representation of the user. A persona system initiates content being targeted to the user via a computing-based client device when the user is represented on-line as a first persona, and then initiates different content being targeted to the user via the computing-based client device when the user is represented on-line as a second persona.

### BRIEF DESCRIPTION OF THE DRAWINGS

The same numbers are used throughout the drawings to reference like features and components:

FIG. 1 illustrates an exemplary content targeting system in which embodiments of user persona content targeting can be implemented.

FIG. 2 illustrates an exemplary user persona environment in which embodiments of user persona content targeting can be implemented.

FIG. 3 illustrates exemplary method(s) for user persona content targeting.

FIG. 4 illustrates exemplary method(s) for user persona content targeting.

FIG. 5 illustrates various components of an exemplary client device in which embodiments of user persona content targeting can be implemented.

### DETAILED DESCRIPTION

User persona content targeting is described in which embodiments provide that media content of various types, such as advertisements or interactive content, can be targeted to a user based not only on a static profile of the user, but also based on various personas and/or on-line interactions of the user. The personas are selectable and/or configurable by the user to represent a personification of the user in different contextual manners when the user interacts on-line. As such, advertisements and content can be targeted and relevant based on a currently selected persona of a user which can also represent a mind-set, intent, or a particular content interaction mode of the user. By targeting advertisements and content based on user mind-set or intent, the targeted media content can be more relevant to the user and a better investment for advertisers.

While aspects of the described systems and methods for user persona content targeting can be implemented in any number of different computing systems, environments, television-based entertainment systems, and/or configurations, embodiments of user persona content targeting are described in the context of the following exemplary system architecture(s).

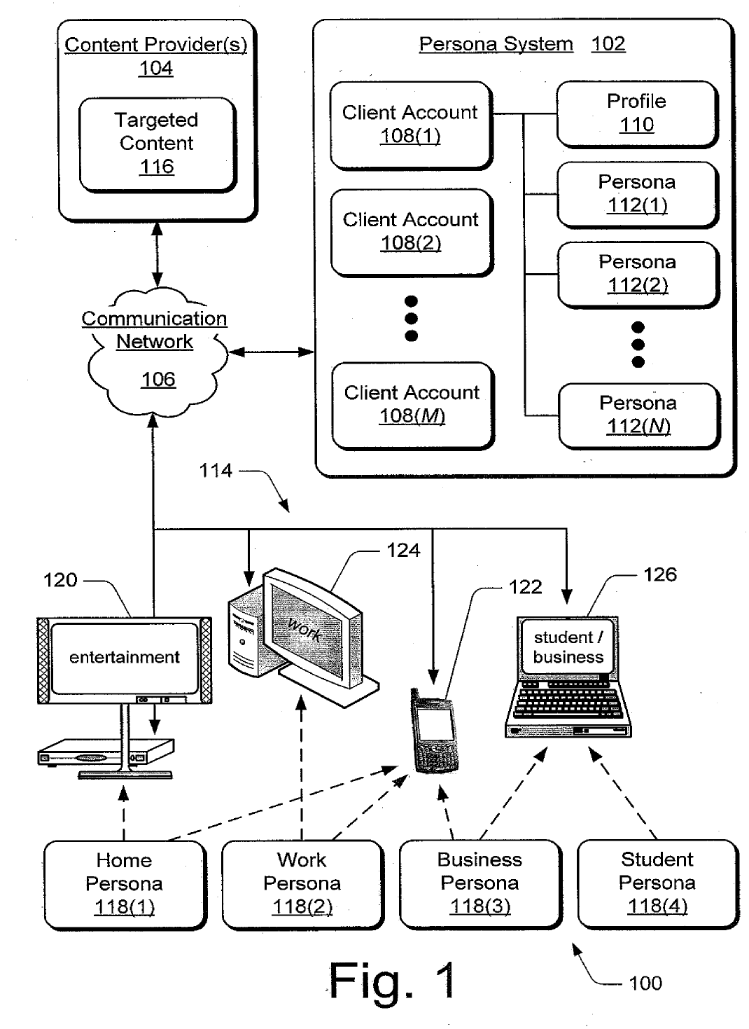

FIG. 1 illustrates an exemplary user persona content targeting system 100 in which embodiments of user persona content targeting can be implemented. The system 100 includes a persona system 102, one or more content providers 104, and a communication network 106. The communication network 106 can be implemented as any one or combination of a wide area network (e.g., the Internet), an intranet, an IP-based network, broadcast network, or other media content distribution network. Additionally, network 106 can be implemented using any type of network topology and any network communication protocol, and can be represented or otherwise implemented as a combination of two or more networks.

In this example, the persona system 102 includes one or more client accounts 108(1-M), each of which can have an associated profile 110 and one or more user personas 112(1-N). The profile 110 can include information that identifies the corresponding user such as by zip code, gender, marital status, and any other type of profile information which provides an on-line identity of the user. A client account 108 corresponds to a user of various computing-based device(s) 114, and each associated persona 112(1-N) is a different on-line representation of the user. A persona is established by a user as a contextual representation of them self in a social, on-line environment. A persona of a user can represent a mind-set, intent, or a particular content interaction mode of the user, and the persona system 102 can initiate content 116 being targeted to the user based on a currently selected, or active, persona of the user.

In this example targeting system 100, the user has four different personas 118(1-4) that each represent a personification of the user in a different contextual manner when the user interacts on-line, and from which the user can choose from. The personas 118(1-4) of the user, however, may not correlate with the information in profile 110 to reflect a true identity of the user. Generally, the profile 110 of the user is generated when the client account 108(1) is established.

The user has a home persona 118(1) that is selectable when the user is interested in television-based content, entertainment-information, interacting with friends and family, and the like. The home persona 118(1) of the user can be associated with a television-based entertainment and information system 120 and/or a portable computing-based device 122, such as a cell phone combination PDA (personal digital assistant), or other communicatively-enable device. The user can interact on-line via the television-based system 120 which can also be implemented as a gaming system to interact with friends in an on-line gaming environment. A television-based client device, gaming console, or other media system component of the television-based system 120 can be implemented with any number and combination of differing components as described with reference to the exemplary client device 600 shown in FIG. 6. When represented on-line by the home persona 118(1), the user will generally have an activity and/or entertainment mindset, and can be targeted with advertisements or other activity-based content that may be of interest to the user.

The user also has a work persona 118(2) that is selectable to represent the user when in a work or office environment, and which can be associated with an office computer 124 and/or the cell phone device 122. When represented on-line by the work persona 118(2), the user will generally have a working mindset and may access and/or receive stock quotes, advertisements, and other work-related content via the office computer 124 or cell phone device 122, rather than sports scores and the weekend weather report when represented on-line by the home persona 118(1).

The user also has a business persona 118(3) that is selectable to represent when the user is involved with the management of a small business owned by the user. The business persona 118(3) of the user can be associated with the cell phone device 122 and/or a portable computing-based device 126. When represented on-line by the business persona 118(3), the user will generally have a business mindset and may access and/or receive business-related content such as business development tools and marketing information, advertisements related to building a business, and other business-related content via the cell phone device 118 and/or the portable computer 122.

The user also has a student persona 118(4) in this example that is selectable to represent the user when involved with advancing his or her education. The student persona 118(4) of the user can be associated with the portable computing device 122 via which the user may access and/or receive research content, project-based content, a calendar, educational-based advertisements, and other similar educational media content.

When the user is involved with education and represented on-line as the student persona 118(4), the user is likely not interested in the entertainment and information associated with the home persona 118(1), and would likely want to avoid interruption from the cell phone device 122 and/or work related content associated with the work persona 118(2). Similarly, when the user is home and relaxing, the user will likely not be working on education-related matters associated with the student persona 118(4), and would want to avoid work related content associated with the work persona 118(2). Accordingly, the user will not likely be receptive to receiving educational-related or work-related content that is targeted to the user when the user is represented on-line by the home persona 118(1).

In this example, client account 108(1) maintained by the persona system 102 corresponds to the referenced user and the personas 112(1-N) correspond to the user personas 118(1-4). The persona system 102 can initiate media content 116 being targeted to the user based on any type of on-line interaction, and based on the context of a user persona 118(1-4). The content provider(s) 104 deliver the targeted content 116 to any one or combination of the computing-based client devices 114 utilized by the user, such as the television-based system 120, the cell phone device 122, the office computer 124, the portable computer 126, a VOIP-enabled device, a gaming console, and any other types of on-line communication enabled devices.

A client device 114 can receive the targeted content 116 as any form of audio, video, and/or image media content when initiated by the persona system 102 based on a user persona 118(1-4). For example, a computing-based client device 114 can receive targeted content 116 in any form of advertising content, recommendations, profile information, business-related content, entertainment-related content, desktop information, television-based content, Web browsing related media content, radio broadcast information such as a calendar or the weather targeted to a portable device, and as any other types of targeted media content.

The persona system 102 can initiate that the content 116 be targeted to the user when the user is represented on-line as a first persona, and then switch to initiate that a different type of content be targeted to the user when the user is represented on-line as a second persona. The persona system 102 can determine that the on-line representation of the user has been switched from one persona to another to adjust the overall experience for the user based on the active persona. In an embodiment of user persona content targeting, the user can switch from one persona 118 to another, such as via a selectable control displayed on an interactive user interface on any of the computing-based client devices 114. Additionally, the user does not have to log-out and then log back on-line to switch personas 118. In an example, the user can be at work and represented on-line by the work persona 118(2) via the office computer 124, but then switch to the home persona 118(2) via the cell phone device 122 during a lunch break to check on personal matters. Further, the user can be represented on-line as both the work persona 118(2) and the home persona 118(1) at the same time via the two different devices.

In alternate embodiments of user persona content targeting, the persona system 102 can switch the on-line representation of the user from one persona 118 to another based on triggers, or indicators. For example, the persona system 102 can determine the use of an email account (or other type of service-based account) associated with a first persona of the user, and then switch the on-line representation of the user from the first persona to a second persona based on the use of a different email account that is associated with the second persona. For example, the user may log-on to a work-based email account when at the office using the office computer 124, and then log-on to a business email account after work hours when conducting business via the portable computer 126. Similarly, the user may then log-on to a student email account via the same portable computer 126 which is recognized by the persona system 102 as a switch in the on-line representation of the user to the student persona 118(4).

In another embodiment, the persona system 102 can switch the on-line representation of the user from a first persona to a second persona based on a time of day. For example, the persona system 102 recognizes the on-line representation of the user as the work persona 118(2) from 8:00 a.m. until 6:00 p.m. at which time the persona system switches to recognize one of the other user personas 118. This time-based switch in personas may also be day of the week specific. For example, the user may attend evening classes on Mondays and Wednesdays, in which case the persona system 102 can switch from the work persona 118(2) to the student persona 118(4) after work on Mondays and Wednesdays. On the other days of the week, the persona system 102 can switch from the work persona 118(2) to the home persona 118(1) after work.

In another embodiment, the persona system 102 can switch the on-line representation of the user from a first persona to a second persona based on the type of client device 114 via which the user interacts with and is represented by on-line. For example, the persona system 102 can recognize that the user logs-on at the office computer 124 and defaults to the work persona 118(2). When the user leaves work and logs-on via the portable computer 126, the persona system 102 can then default to (optionally configurable) the business persona 118(3) or the student persona 118(4).

Similarly, the persona system 102 can monitor the types of media content accessed by the user and determine a persona 118(1-4) of the user based on the types of media content that are accessed. For example, the persona system 102 can recognize the user being represented on-line by the work persona 118(2), further recognize that the user is accessing sports scores, the weekend weather report, an evening television programming listing, and/or other types of non-work media content, and determine that he user has switched to the home persona 118(1). Accordingly, the persona system 102 can then initiate content 116 being targeted to the user based on the home persona 118(1) rather than based on the work persona 118(2).

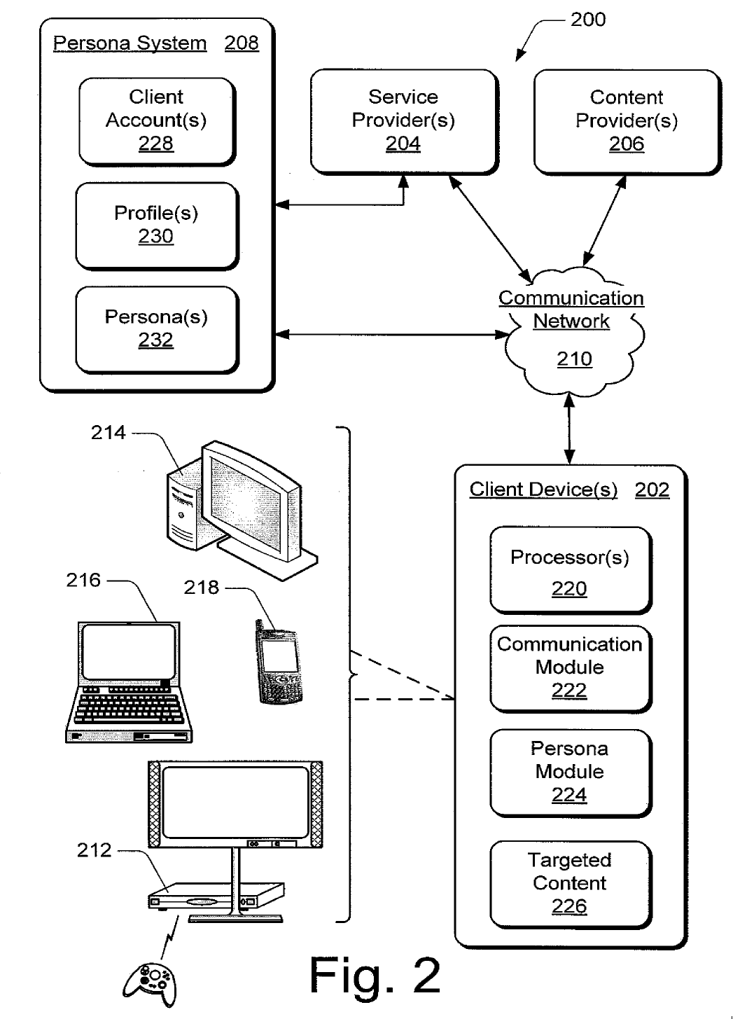

FIG. 2 illustrates an exemplary user persona environment 200 in which embodiments of user persona content targeting can be implemented. The environment 200 includes one or more client device(s) 202, service provider(s) 204, content provider(s) 206, and a persona system 208, all of which are configured for communication via a communication network 210. Any of the systems and/or devices can be configured for network access in any number of embodiments and varieties of implementation.

The communication network 210 can be implemented as any one or combination of a wide area network (e.g., the Internet), a local area network (LAN), an intranet, an IP-based network, broadcast network, a public telephone network, a wireless network, or other media content distribution network. Additionally, communication network 210 can be implemented using any type of network topology and any network communication protocol, and can be represented or otherwise implemented as a combination of two or more networks. For instance, a service provider 204 can be communicatively coupled to the persona system 208 via a corporate intranet, and may also be communicatively coupled to the client device(s) 202 via the Internet.

A client device 202 can be implemented as any one or more of a television-based client device and/or gaming console 212, a desktop computer 214, a portable computer 216, or as any other computing-based device, such as a cell phone 218, a mobile station, a set-top box, a digital video recorder (DVR) and playback system, an appliance device, and as any other type of computing-based client device. Thus, a client device 202 can range from full resource devices with substantial memory and processor resources (e.g., personal computers and gaming consoles) to low-resource devices with limited memory and/or processing resources (e.g., traditional set-top boxes and hand-held game consoles). A client device 202 may also be associated with a user (i.e., a person) and/or an entity that operates a client device 202 such that the client device describes logical clients that include users, software, and/or devices.

In this example, a client device 202 includes one or more processor(s) 220, a communication module 222, and a persona module 224 each of which can be implemented as computer executable instructions and executed by the processor(s) 220 to implement embodiments of user persona content targeting. Additionally, a client device 202 may be implemented with any number and combination of differing components as further described below with reference to the exemplary client device 600 shown in FIG. 6. The client device(s) 202 receive targeted content 226, as well as any other form of media content, from one or more of the content provider(s) 206 via the communication network 210.

The communication module 222 of a client device 202 can utilize the functionality represented by the persona module 224 of the client device 202. In an implementation, the persona module 224 is executable to communicate with the persona system 208, such as with a persona manager module (not shown), to create and manage the personals) 232 that are associated with a client account 228. In another implementation, the persona module 224 can include the functionality of a persona manager module and the persona(s) 232 such that the functionality of the persona system 208 is incorporated locally at a client device 202. A variety of other examples are also contemplated. For example, a service provider 204 may be implemented to incorporate the functionality of the persona system 208.

A client device 202 can also interact with one or more of the service providers 204 to specify an external representation. For example, an external representation can be a user name and password which enables a client 202 to access a service provider 204 by logging on to the respective services, and thus, is used to represent the client 202 to the service provider(s) 204. An external representation can also be configured to represent a client 202 to other client devices that access a service provider 204. For instance, the client devices 202 can access a service provider 204 which provides instant messaging through execution of a respective communication module.

Each of the clients 202 can specify a user tile (e.g., an “avatar”) and/or an alias to represent the respective client to other clients participating in an instant messaging session. Thus, each of the clients 202, when participating in the instant messaging session, is provided with an external representation of the other clients participating in the session, and therefore may readily determine who sent a message and specify who is to receive a message. Besides being implemented for instant messaging, the communication module 222 at a client device 202 can be implemented in a variety of ways to access the service provider(s) 204 via the communication network 210, such as by way of a Web browser.

The service provider(s) 204 can be configured with any combination of differing components and in a variety of ways to provide a wide variety of services. In addition to instant messaging as described above, a service provider 204 can provide for email communications (i.e., as an email provider), message boards, newsgroups, and so on. To provide these and other services, each service provider 204 can be implemented with a service manager module (not shown) which is executable to provide services to the client device(s) 202 over the communication network 210, such as through configuration as Web services.

In this exemplary user persona environment 200, the persona system 208 includes client account(s) 228 as well as associated profile(s) 230 and user personals) 232 to implement embodiments of user persona content targeting as described with reference to the exemplary user persona content targeting system 100 and the persona system 102 shown in FIG. 1. The persona system 208 is accessible by the client device(s) 202 and the service provider(s) 204 via the communication network 210. The persona system 208 can be implemented to include a persona manager module (not shown) that is executable to manage the client account(s) 228, as well as the associated profile(s) 230 and the user persona(s) 232, all of which can be maintained with a storage component of the persona system 208. A client account 228 includes data utilized by a respective client 202 to represent the client to any one or more of the service provider(s) 204, such as to logon to a service provider 204.

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, examples of which are described with reference to the exemplary client device 600 shown in FIG. 6. Further, the features of user persona content targeting as described herein are platform-independent such that the techniques may be implemented on a variety of commercial computing platforms having a variety of processors.

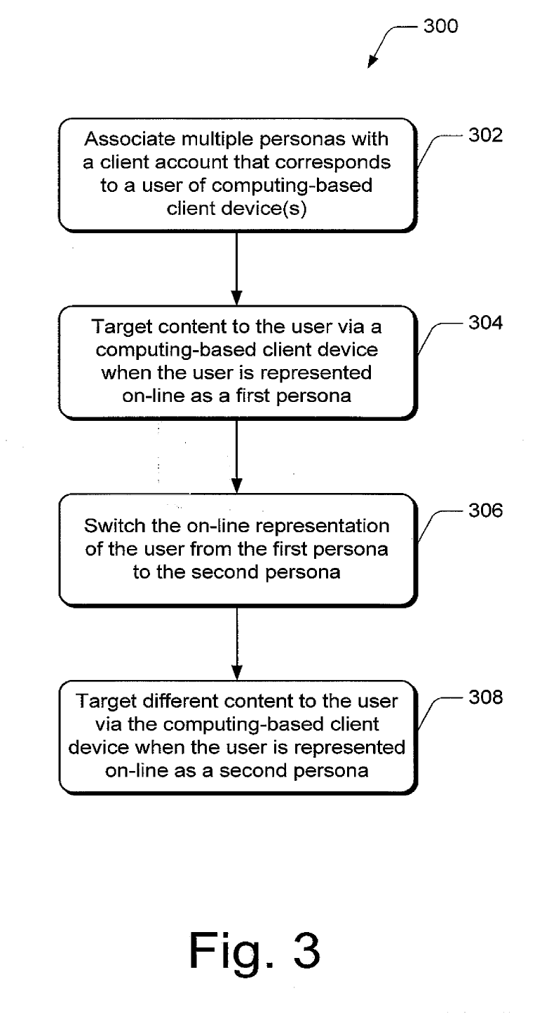

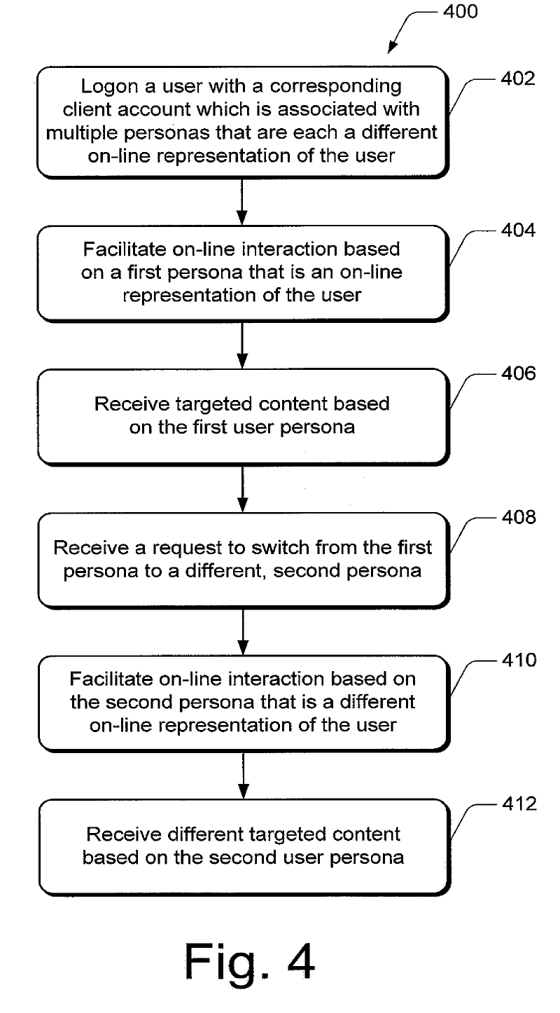

Methods for user persona content targeting, such as exemplary methods 300 and 400 described with reference to respective FIGS. 3 and 4, may be described in the general context of computer executable instructions. Generally, computer executable instructions can include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

FIG. 3 illustrates an exemplary method 300 for user persona content targeting and is described with reference to the exemplary content targeting system 100 shown in FIG. 1, and with reference to the exemplary user persona environment 200 shown in FIG. 2. The order in which the method is described is not intended to be construed as a limitation, and any number of the described method blocks can be combined in any order to implement the method, or an alternate method. Furthermore, the method can be implemented in any suitable hardware, software, firmware, or combination thereof.

At block 302, multiple personas that are each a different on-line representation of a user are associated with a client account that corresponds to a user of computing-based client device(s). For example, the persona system 102 (FIG. 1) maintains a client account 108(1) that corresponds to a user of any one or more computing-based client devices 114. The client account 108(1) is associated with personas 112(1-N) which, in the FIG. 1 example, correspond to the user personas 118(1-4) of the user.

At block 304, content is targeted to the user via a computing-based client device when the user is represented on-line as a first persona. For example, the persona system 102 initiates that content 116 be targeted to the user when, for example, the user is represented on-line by the work persona 118(2). The content 116 can be targeted to the user via the office computer 124 and/or via the cell phone device 122, both of which are associated with the work persona 118(2).

At block 306, the on-line representation of the user is switched from the first persona to the second persona. For example, the persona system 102 can determine that the user has switched from the work persona 118(2) to another of the user personas 118 and adjust the overall experience for the user based on the active persona. The user can switch from one persona 118 to another, or the persona system 102 can switch the user personas.

In one embodiment, the persona system 102 can determine the use of an email account, other service-based account, or a particular client device associated with a first persona of the user, and then switch the on-line representation of the user from a first persona to a second persona based on the use of a different email account, different service-based account, and/or different client device that is associated with the second persona. The persona system 102 can also switch the on-line representation of the user from a first persona to a second persona based on a time of day and/or based on which computing-based client device the user interacts with and is represented by on-line. Similarly, the persona system 102 can monitor the types of media content accessed by the user and determine a persona 118(1-4) of the user based on the types of media content that are accessed.

At block 308, different content is targeted to the user via the computing-based client device when the user is represented on-line as a second persona. For example, the persona system 102 initiates different content 116 being targeted to the user when the user switches personas and is represented on-line by, for example, the home persona 118(1). The different content 116 can be targeted to the user via the entertainment system 120 and/or via the cell phone device 122, both of which are associated with the home persona 118(1).

FIG. 4 illustrates an exemplary method 400 for user persona content targeting and is described with reference to the exemplary content targeting system 100 shown in FIG. 1, and with reference to the exemplary user persona environment 200 shown in FIG. 2. The order in which the method is described is not intended to be construed as a limitation, and any number of the described method blocks can be combined in any order to implement the method, or an alternate method. Furthermore, the method can be implemented in any suitable hardware, software, firmware, or combination thereof.

At block 402, a user is logged into an on-line service with a corresponding client account which is associated with multiple personas that are each a different on-line representation of the user. For example, a computing-based client device 202 (FIG. 2) facilitates logging a user into an on-line service of a service provider 204. A client account 228 maintained by the persona system 208 corresponds to the user, as does a profile 230 and one or more user personas 232.

At block 404, on-line interaction is facilitated based on a first persona that is an on-line representation of the user. For example, the computing-based client device 202 facilitates user interaction with the on-line service via the communication network 210 when the user is represented on-line by a first user persona. At block 406, targeted content is received based on the first user persona. For example, the computing-based client device 202 receives targeted content 226 from a content provider 206 when initiated by the persona system 208 and based on the first user persona via which the user is represented on-line.

At block 408, a request is received to switch from the first persona to a different, second persona. For example, the computing-based client device 202 receives a request from the user or from the persona system 208 to switch the on-line representation of the user to a different persona. At block 410, on-line interaction is facilitated based on the second persona that is a different on-line representation of the user. For example, the computing-based client device 202 facilitates on-line user interaction when the user is represented on-line by the second user persona. At block 412, different targeted content is received based on the second user persona. For example, the computing-based client device 202 receives different targeted content 226 from a content provider 206 when initiated by the persona system 208 and based on the second user persona via which the user is represented on-line.

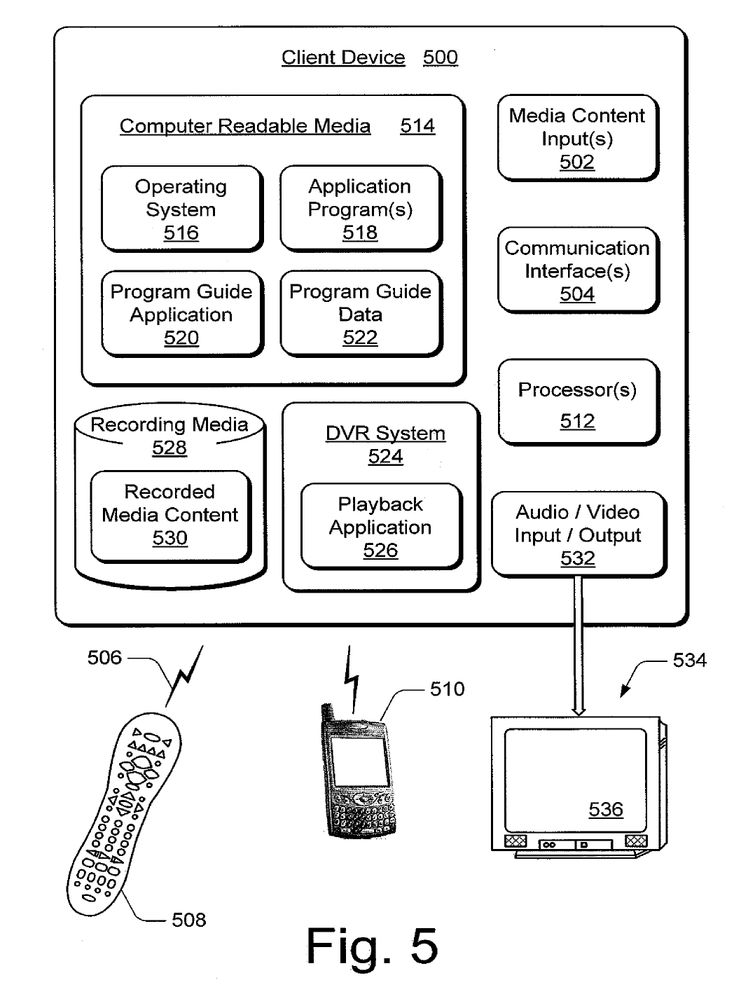

FIG. 5 illustrates various components of an exemplary client device 500 which can be implemented as any form of a computing, electronic, and/or television-based client device, and in which embodiments of user persona content targeting can be implemented. For example, the exemplary client device 500 can be implemented as a television-based client device or as a gaming console in an entertainment system 120, 212 shown in respective FIGS. 1-2. Additionally, various component configurations of the exemplary client device 500 can be implemented as any one or more of the computing-based client devices 114, 202 shown in respective FIGS. 1-2, such as the desktop computer 124, the cell phone device 122, and/or the portable computing device 126.

Client device 500 includes one or more media content inputs 502 which may include Internet Protocol (IP) inputs over which streams of media content are received via an IP-based network. Device 500 further includes communication interface(s) 504 which can be implemented as any one or more of a serial and/or parallel interface, a wireless interface, any type of network interface, a modem, and as any other type of communication interface. A wireless interface enables client device 500 to receive control input commands 506 and other information from an input device, such as from remote control device 508, a portable computing-based device (such as a cellular phone) 510, or from another infrared (IR), 802.11, Bluetooth, or similar RF input device.

A network interface provides a connection between the client device 500 and a communication network by which other electronic and computing devices can communicate data with device 500. Similarly, a serial and/or parallel interface provides for data communication directly between client device 500 and the other electronic or computing devices. A modem facilitates client device 500 communication with other electronic and computing devices via a conventional telephone line, a DSL connection, cable, and/or other type of connection.

Client device 500 also includes one or more processors 512 (e.g., any of microprocessors, controllers, and the like) which process various computer executable instructions to control the operation of device 500, to communicate with other electronic and computing devices, and to implement embodiments of user persona content targeting. Client device 500 can be implemented with computer readable media 514, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer readable media 514 provides data storage mechanisms to store various information and/or data such as software applications and any other types of information and data related to operational aspects of client device 500. For example, an operating system 516 and/or other application programs 518 can be maintained as software applications with the computer readable media 514 and executed on processor(s) 512 to implement embodiments of user persona content targeting.

For example, client device 500 can be implemented to include a program guide application 520 that is implemented to process program guide data 522 and generate program guides for display which enable a viewer to navigate through an onscreen display and locate broadcast programs, recorded programs, video on-demand programs and movies, interactive game selections, network-based applications, and other media access information or content of interest to the viewer. The application programs 518 can include the persona system 102, 208 to implement features and embodiments of user persona content targeting as described herein. The client device 500 can also include a DVR system 524 with playback application 526, and recording media 528 to maintain recorded media content 530.

The client device 500 also includes an audio and/or video output 532 that provides audio and video to an audio rendering and/or display system 534, or to other devices that process, display, and/or otherwise render audio, video, and image data. Video signals and audio signals can be communicated from device 500 to a display device 536 via an RF (radio frequency) link, S-video link, composite video link, component video link, analog audio connection, or other similar communication link. Alternatively, the audio rendering and/or display system 534 is/are integrated components of the exemplary client device 500.

Although embodiments of user persona content targeting have been described in language specific to structural features and/or methods, it is to be understood that the subject of the appended claims is not necessarily limited to the specific features or methods described. Rather, the specific features and methods are disclosed as exemplary implementations of user persona content targeting.

1. A targeted content system, comprising:
a client account corresponding to a user of a computing-based client device, the client account associated with multiple personas that are each a different on-line representation of the user;
a persona system configured to:
maintain the client account and the multiple personas associated with the client account;
initiate content targeted to the user via the computing-based client device when the user is represented on-line as a first persona; and
initiate different content targeted to the user via the computing-based client device when the user is represented on-line as a second persona.

2. A targeted content system as recited in claim 1, wherein the persona system is further configured to determine that the on-line representation of the user switched from the first persona to the second persona.

3. A targeted content system as recited in claim 1, wherein the persona system is further configured to switch the on-line representation of the user from the first persona to the second persona based on a time of day.

4. A targeted content system as recited in claim 1, wherein the persona system is further configured to determine the use of a first email account associated with the first persona, and switch the on-line representation of the user from the first persona to the second persona based on the use of an email account associated with the second persona.

5. A targeted content system as recited in claim 1, wherein the persona system is further configured to:
initiate the content targeted to the user as work-related content based on a work associated persona of the user; and
initiate the different content targeted to the user as activity-related content based on a non-work associated persona of the user.

6. A targeted content system as recited in claim 1, wherein the persona system is further configured to initiate the content targeted to the user based on the first persona and a profile of the user corresponding to the client account.

7. A targeted content system as recited in claim 1, wherein the persona system is further configured to initiate the content targeted to the user based on the first persona and the type of computing-based client device via which the user is represented on-line.

8. A targeted content system as recited in claim 1, wherein the persona system is further configured to:
monitor accessed content;
determine a persona of the user based on the accessed content; and
initiate the content targeted to the user based on the determined persona.

9. A method, comprising:
associating multiple personas with a client account that corresponds to a user of client devices, the multiple personas each being a different on-line representation of the user;
targeting content to the user when the user is represented on-line as a first persona; and
targeting different content to the user when the user is represented on-line as a second persona.

10. A method as recited in claim 9, further comprising determining that the on-line representation of the user switched from the first persona to the second persona.

11. A method as recited in claim 9, further comprising switching the on-line representation of the user from the first persona to the second persona based on a time of day.

12. A method as recited in claim 9, further comprising determining the use of a first email account associated with the first persona to target the content to the user, and determining the use of a second email account associated with the second persona to target the different content to the user.

13. A method as recited in claim 9, wherein:
targeting the content to the user includes targeting work-related content to the user when represented on-line by a work associated persona; and
targeting the different content to the user includes targeting non-work related content to the user when represented on-line by at least one of an entertainment associated persona, a home associated persona, a family associated persona, a friends associated persona, an activity associated persona, or a student associated persona.

14. A method as recited in claim 9, wherein targeting the content to the user includes targeting the content based on the first persona and a profile of the user corresponding to the client account.

15. A method as recited in claim 9, wherein targeting the content to the user includes targeting the content based on the first persona and a type of computing-based client device via which the user is represented on-line.

16. A method as recited in claim 9, further comprising:
monitoring accessed content which is accessed by the user via the computing-based client device;
determining a persona of the user based on the accessed content; and
wherein targeting the content to the user includes targeting the content based on the determined persona.

17. A method, comprising:
associating multiple personas with a client account, the multiple personas each being a different on-line representation of a user;
targeting content to the user via a first client device that corresponds to a first persona of the user; and
targeting different content to the user via a second client device that corresponds to a second persona of the user.

18. A method as recited in claim 17, further comprising switching targeting the content via the first client device to targeting the different content via the second client device based on a time of day.

19. A method as recited in claim 17, further comprising switching targeting the content via the first client device to targeting the different content via the second client device when determining a use associated with the second client device.

20. A method as recited in claim 17, further comprising determining the use of a first service-based account associated with the first persona to target the content to the user, and determining the use of a second service-based account associated with the second persona to target the different content to the user.
